(19) United States
(12) Patent Application Publication
(10) Pub. No.: US 2026/0323667 A1
(43) Pub. Date: Oct. 15, 2026

(54) EXTENDED CHANNEL USAGE PROCEDURE

(71) Applicant: Samsung Electronics Co., Ltd., Suwon-si (KR)

(72) Inventors: Rubayet Shafin, Frisco, TX (US); Boon Loong Ng, Plano, TX (US); Peshal Nayak, Plano, TX (US); Yue Qi, Plano, TX (US); Vishnu Vardhan Ratnam, Plano, TX (US); Bilal Sadiq, Plano, TX (US)

(21) Appl. No.: 19/636,751

(22) Filed: Apr. 1, 2026

Related U.S. Application Data
(60) Provisional application No. 63/788,585, filed on Apr. 14, 2025.

(51) Int. Cl. H04W 72/25; H04W 72/0446

(52) U.S. Cl. CPC H04W 72/25; H04W 72/0446

(57) ABSTRACT

Methods and systems for an extended channel usage procedure. A method performed by an access point (AP) device includes generating a frame to advertise different sets of recommended channels that can be deemed as conducive for peer-to-peer (P2P) communication. The frame includes an extended channel usage element that includes a channel usage parameter set field. The channel usage parameter set field includes one or more channel recommendations. For a first of the one or more channel recommendations, a recommendation periods information field in the channel usage parameter set field, the recommendation periods information field indicating a series of time windows during which the first channel recommendation identified by the channel usage parameter set field is applicable. The method also includes transmitting the frame to advertise the recommendation for P2P communication.

### CROSS-REFERENCE TO RELATED APPLICATIONS AND CLAIM OF PRIORITY

The present application claims priority to U.S. Provisional Patent Application No. 63/788,585, filed on Apr. 14, 2025. The contents of the above-identified patent documents are incorporated herein by reference.

### TECHNICAL FIELD

The present disclosure relates generally to wireless communication systems. more specifically, the present disclosure relates to a system and method for an extended channel usage procedure.

### BACKGROUND

Peer-to-peer (P2P) communication in IEEE 802.11 wireless local area networks (WLANs) is recognized as a significant advancement over traditional access point (AP)-mediated architectures, as direct data transmission between devices is enabled without the need for an intermediate AP device. Through standards such as Wi-Fi Direct, P2P groups can be formed in which multiple devices are permitted to communicate directly, offering benefits such as reduced latency, improved energy efficiency, and support for applications including file sharing, streaming media, smart home systems, and Internet of Things (IoT) networks. However, challenges in P2P group management are also presented, as sophisticated mechanisms are required to coordinate resource allocation, maintain security, and ensure seamless operation as devices join or leave the network.

### SUMMARY

The present disclosure relates generally to wireless communication systems and, more specifically, the present disclosure relates to a system and method for an extended channel usage procedure.

In one embodiment, a method performed by an access point (AP) device is provided. The method includes generating a frame to advertise different sets of recommended channels that can be deemed as conducive for peer-to-peer (P2P) communication. The frame includes an extended channel usage element that includes a channel usage parameter set field. The channel usage parameter set field includes one or more channel recommendations. For a first of the one or more channel recommendations, a recommendation periods information field in the channel usage parameter set field, the recommendation periods information field indicating a series of time windows during which the first channel recommendation identified by the channel usage parameter set field is applicable. For a first of the one or more channel recommendations, a recommendation timeout information field in the channel usage parameter set field, the recommendation timeout information field indicating a time when the first channel recommendation identified by the channel usage parameter set field expires. The method also includes transmitting the frame to advertise the recommendation for P2P communication.

In another embodiment, method performed by a non-access point (AP) station (STA). The method includes receiving a frame to advertise different sets of recommended channels that can be deemed as conducive for peer-to-peer (P2P) communication. The frame includes an extended channel usage element. The extended channel usage element has a channel usage parameter set field that includes one or more channel recommendations, such as a first channel recommendation and a second channel recommendation. For a first of the one or more channel recommendations, a recommendation periods information field in the channel usage parameter set field, the recommendation periods information field indicating a series of time windows during which the first channel recommendation identified by the channel usage parameter set field is applicable. For a first of the one or more channel recommendations, a recommendation timeout information field in the channel usage parameter set field, the recommendation timeout information field indicating a time when the first channel recommendation identified by the channel usage parameter set field expires. The method also includes transmitting a response frame based on the recommendation for P2P communication.

In yet another embodiment, an electronic device is provided. The electronic device includes a transceiver, and a processor operably coupled to the transceiver. The processor is configured to cause the electronic device to generate a frame to advertise different sets of recommended channels that can be deemed as conducive for peer-to-peer (P2P) communication. The frame includes an extended channel usage element that has a channel usage parameter set field including one or more channel recommendations. For a first of the one or more channel recommendations, a recommendation periods information field in the channel usage parameter set field, the recommendation periods information field indicating a series of time windows during which the first channel recommendation identified by the channel usage parameter set field is applicable. For a first of the one or more channel recommendations, a recommendation timeout information field in the channel usage parameter set field, the recommendation timeout information field indicating a time when the first channel recommendation identified by the channel usage parameter set field expires. The processor is also configured to cause the electronic device to transmit the frame to advertise the recommendation for P2P communication.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example AP device according to embodiments of the present disclosure;

FIG. 2B illustrates an example STA according to embodiments of the present disclosure;

FIG. 3 illustrates an example peer-to-peer communication system supporting an enhanced channel usage procedure according to embodiments of the present disclosure;

FIG. 4 illustrates an example extended channel usage element format supporting an enhanced channel usage procedure according to embodiments of the present disclosure;

FIG. 5 illustrates an example channel usage parameter set field format supporting an enhanced channel usage procedure according to embodiments of the present disclosure;

FIG. 6 illustrates an example presence indicator field supporting an enhanced channel usage procedure according to embodiments of the present disclosure;

FIG. 7 illustrates an example recommendation periods information field format supporting an enhanced channel usage procedure according to embodiments of the present disclosure;

FIG. 8 illustrates an example flow chart of a method for an extended channel usage procedure according to embodiments of the present disclosure; and

FIG. 9 illustrates an example flow chart of a method for an extended channel usage procedure according to embodiments of the present disclosure.

### DETAILED DESCRIPTION

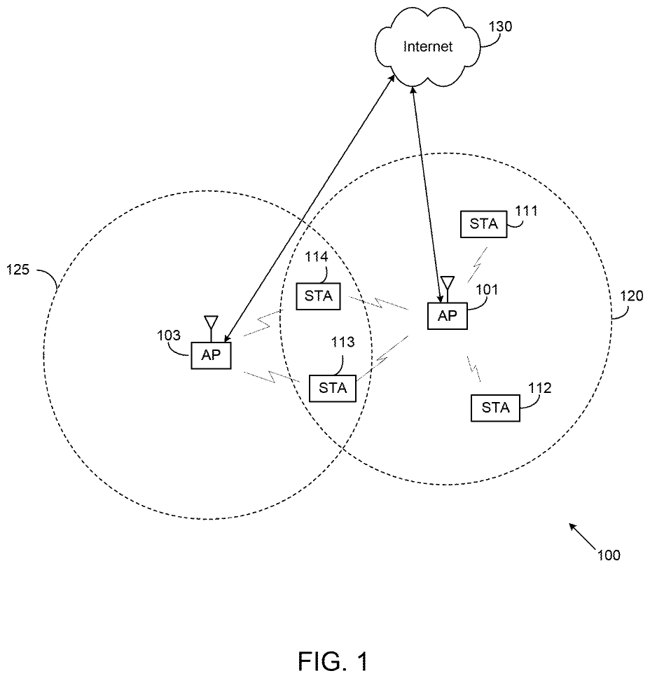

FIG. 1 through FIG. 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As discussed above, peer-to-peer (P2P) communication in IEEE 802.11 wireless local area networks (WLANs) is recognized as a significant advancement over traditional access point (AP)-mediated architectures, as direct data transmission between devices is enabled without the need for an intermediate AP device. Through standards such as Wi-Fi Direct, P2P groups can be formed in which multiple devices are permitted to communicate directly, offering benefits such as reduced latency, improved energy efficiency, and support for applications including file sharing, streaming media, smart home systems, and Internet of Things (IoT) networks.

However, challenges in P2P group management are also presented, as sophisticated mechanisms are required to coordinate resource allocation, maintain security, and ensure seamless operation as devices join or leave the network.

Standards within the 802.11 family, such as Wi-Fi Direct and other specifications like 802.11z, provide the framework for P2P capabilities. These standards ensure compatibility and security, often incorporating encryption methods like WPA2 or WPA3 to protect data integrity and prevent unauthorized access.

With respect to addressing and routing, devices in a P2P group utilize unique identifiers such as MAC addresses to target communications accurately. The use of such identifiers ensures that data packets reach the intended destinations without confusion or misdirection.

Although P2P groups operate independently of an AP device for data transmission, the role of the AP device may still be relevant during initial authentication or resource management. In such cases, the AP device helps to ensure a smooth and secure communication environment even when direct device-to-device communication is the primary mode of data exchange.

Accordingly, the present disclosure provides systems and methods for an extended channel usage procedure. As described herein, the present disclosure includes systems and methods that use an extended channel usage element, such as in a beacon or probe frame of an AP device, that channel recommendations for P2P communication along with timing information. The present disclosure, thus, enables an enhanced channel usage procedure that ensures a smooth and secure communication environment.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes AP devices 101 and 103. The AP devices 101 and 103 communicate with at least one network 130, such as the Internet, a proprietary Internet Protocol (IP) network, or other data network. The AP device 101 provides wireless access to the network 130 for a plurality of STAs 111-114 within a coverage area 120 of the AP device 101. The AP devices 101-103 may communicate with each other and with the STAs 111-114 using Wi-Fi or other WLAN communication techniques.

Depending on the network type, other well-known terms may be used instead of “access point” or “AP device,” such as “router” or “gateway.” For the sake of convenience, the term “AP device” is used in this disclosure to refer to network infrastructure components that provide wireless access to remote terminals. In WLAN, given that the AP device also contends for the wireless channel, the AP device may also be referred to as a STA (e.g., an AP device STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP device or contends for a wireless channel in a WLAN, whether the STA is a mobile device (such as a mobile telephone or smartphone) or is normally considered a stationary device (such as a desktop computer, AP device, media player, stationary sensor, television, etc.). This type of STA may also be referred to as a non-AP device STA.

In various embodiments of this disclosure, each of the AP devices 101 and 103 and each of the STAs 111-114 may be an MLD. In such embodiments, AP devices 101 and 103 may be AP device MLDs, and STAs 111-114 may be non-AP device MLDs. Each MLD is affiliated with more than one STA. For convenience of explanation, an AP device MLD is described herein as affiliated with more than one AP device (e.g., more than one AP device STA), and a non-AP device MLD is described herein as affiliated with more than one STA (e.g., more than one non-AP device STA).

Dotted lines show the approximate extents of the coverage areas 120 and 125, which are shown as approximately circular for the purposes of illustration and explanation only. It should be clearly understood that the coverage areas associated with AP devices, such as the coverage areas 120 and 125, may have other shapes, including irregular shapes, depending upon the configuration of the AP devices and variations in the radio environment associated with natural and man-made obstructions.

As described in more detail below, one or more of the AP devices may include circuitry and/or programming for an extended channel usage procedure. Although FIG. 1 illustrates one example of a wireless network 100, various changes may be made to FIG. 1. For example, the wireless network 100 could include any number of AP devices and any number of STAs in any suitable arrangement. Also, the AP device 101 could communicate directly with any number of STAs and provide those STAs with wireless broadband access to the network 130. Similarly, each AP device 101-103 could communicate directly with the network 130 and provide STAs with direct wireless broadband access to the network 130. Further, the AP devices 101 and/or 103 could provide access to other or additional external networks, such as external telephone networks or other types of data networks.

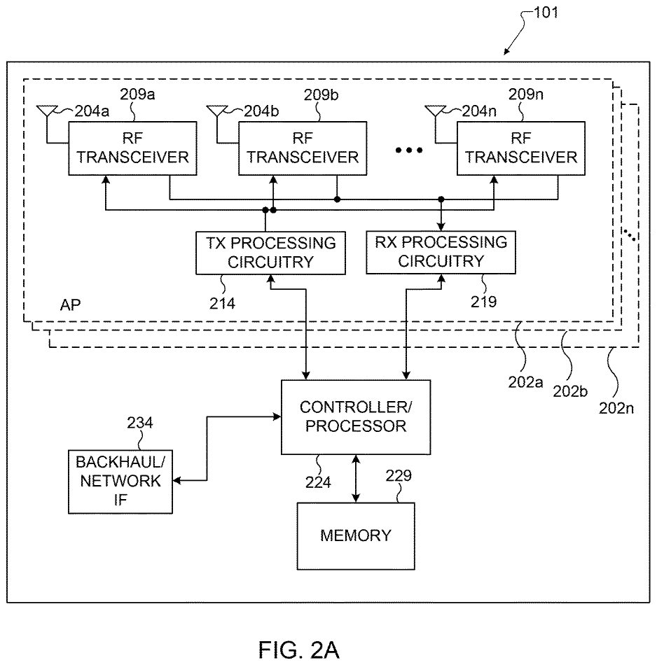

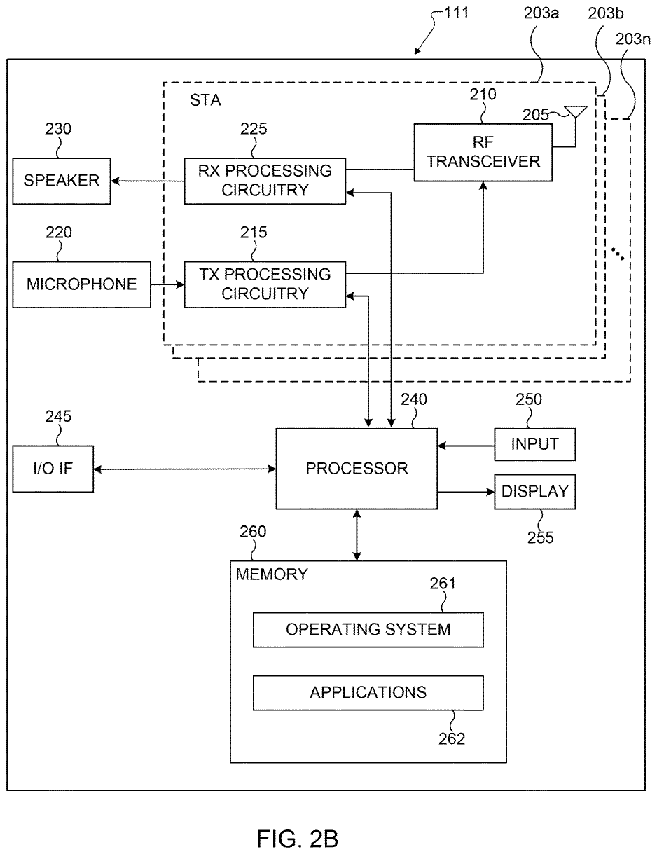

FIG. 2A illustrates an example AP device 101 according to various embodiments of the present disclosure. The embodiment of the AP device 101 illustrated in FIG. 2A is for illustration only, and the AP device 103 of FIG. 1 could have the same or similar configuration. In the embodiments discussed herein below, the AP device 101 is an AP device MLD. However, AP devices come in a wide variety of configurations, and FIG. 2A does not limit the scope of this disclosure to any particular implementation of an AP device.

The AP device MLD 101 is affiliated with multiple AP devices 202a-202n (which may be referred to, for example, as AP device1-APn). Each of the affiliated AP devices 202a-202n includes multiple antennas 204a-204n, multiple RF transceivers 209a-209n, transmit (TX) processing circuitry 214, and receive (RX) processing circuitry 219. The AP device MLD 101 also includes a controller/processor 224, a memory 229, and a backhaul or network interface 234.

The illustrated components of each affiliated AP device 202a-202n may represent a physical (PHY) layer and a lower media access control (LMAC) layer in the open systems interconnection (OSI) networking model. In such embodiments, the illustrated components of the AP device MLD 101 represent a single upper MAC (UMAC) layer and other higher layers in the OSI model, which are shared by all of the affiliated AP devices 202a-202n.

For each affiliated AP device 202a-202n, the RF transceivers 209a-209n receive, from the antennas 204a-204n, incoming RF signals, such as signals transmitted by STAs in the network 100. In some embodiments, each affiliated AP device 202a-202n operates at a different bandwidth, e.g., 2.4 GHz, 5 GHZ, or 6 GHz, and accordingly the incoming RF signals received by each affiliated AP device may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP device 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP device 202a-202n operates at a different bandwidth, e.g., 2.4 GHz, 5 GHZ, or 6 GHz, the outgoing RF signals transmitted by each affiliated AP device may be at a different frequency of RF.

The controller/processor 224 can include one or more processors or other processing devices that control the overall operation of the AP device MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP device MLD 101 by the controller/processor 224 including facilitating an extended channel usage procedure. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP device MLD 101 to communicate with other devices or systems over a backhaul connection or over a network. The interface 234 could support communications over any suitable wired or wireless connection(s). For example, the interface 234 could allow the AP device MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP device MLD 101 may include circuitry and/or programming for an extended channel usage procedure. Although FIG. 2A illustrates one example of AP device MLD 101, various changes may be made to FIG. 2A. For example, the AP device MLD 101 could include any number of each component shown in FIG. 2A. As a particular example, an AP device MLD 101 could include a number of interfaces 234, and the controller/processor 224 could support routing functions to route data between different network addresses. As another particular example, while each affiliated AP device 202a-202n is shown as including a single instance of TX processing circuitry 214 and a single instance of RX processing circuitry 219, the AP device MLD 101 could include multiple instances of each (such as one per RF transceiver) in one or more of the affiliated AP devices 202a-202n. Alternatively, only one antenna and RF transceiver path may be included in one or more of the affiliated AP devices 202a-202n, such as in legacy AP devices. Also, various components in FIG. 2A could be combined, further subdivided, or omitted and additional components could be added according to particular needs.

FIG. 2B illustrates an example non-AP device MLD 111 according to various embodiments of this disclosure. The embodiment of the non-AP device MLD 111 illustrated in FIG. 2B is for illustration only, and the STAs 111-115 of FIG. 1 could have the same or similar configuration. In the embodiments discussed herein below, the STA 111 is a non-AP device MLD. However, STAs come in a wide variety of configurations, and FIG. 2B does not limit the scope of this disclosure to any particular implementation of a STA.

The non-AP device MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP device MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP device MLD 111 represent a single UMAC layer and other higher layers in the OSI model, which are shared by all of the affiliated STAs 203a-203n.

For each affiliated STA 203a-203n, the RF transceiver 210 receives, from the antenna(s) 205, an incoming RF signal transmitted by an AP device of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHZ, 5 GHZ, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP device MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate configuring an extended channel usage procedure. In some embodiments, the controller/processor 240 includes at least one microprocessor or microcontroller.

The processor 240 is also capable of executing other processes and programs resident in the memory 260, such as operations for facilitating an extended channel usage procedure. The controller/processor 240 can move data into or out of the memory 260 as required by an executing process. In some embodiments, the controller/processor 240 is configured to execute a plurality of applications 262, such as applications for facilitating transmission for reception at an associated AP device and an unassociated AP device. The controller/processor 240 can operate the plurality of applications 262 based on the OS program 261 or in response to a signal received from an AP device. The main controller/processor 240 is also coupled to the I/O interface 245, which provides non-AP device MLD 111 with the ability to connect to other devices such as laptop computers and handheld computers. The I/O interface 245 is the communication path between these accessories and the main controller 240.

The processor 240 is also coupled to the touchscreen 250 and the display 255. The operator of the non-AP device MLD 111 can use the touchscreen 250 to enter data into the non-AP device MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP device MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP device 101. In another example, the non-AP device MLD 111 may not include voice communication or the controller/processor 240 could be divided into multiple processors, such as one or more central processing units (CPUs) and one or more graphics processing units (GPUs). Also, while FIG. 2B illustrates the non-AP device MLD 111 configured as a mobile telephone or smartphone, non-AP device MLDs can be configured to operate as other types of mobile or stationary devices.

FIG. 3 illustrates an example peer-to-peer (P2P) communication system 300 supporting an enhanced channel usage procedure according to embodiments of the present disclosure. For ease of explanation, the P2P communication system 300 will be described as including one or more components of the wireless network 100 of FIG. 1, such as the AP device 102; however, the P2P communication system 300 could be implemented using any other suitable device or system. The embodiment of the P2P communication system 300 shown in FIG. 3 is for illustration only. Other embodiments of the P2P communication system 300 could be used without departing from the scope of this disclosure.

As shown in FIG. 3, the P2P communication system 300 includes an AP device 302 that is communicatively coupled to one or more associated STA 312 using one or more UL/DL link 314. The P2P communication system 300 also includes unassociated STA 322 communicatively coupled to each other using one or more direct link 324. Additionally, the one or more of the unassociated STA 322 may be communicatively coupled to one or more of the 321 using one or more of the direct link 324.

The P2P communication system 300 is configured for Wi-Fi networks by relying on the 302 to mediate communications between devices. Additionally, the P2P communication system 300 also configured for P2P communication using direct data transmission between devices without the need for an intermediate AP device.

Existing standards within the 802.11 family, such as Wi-Fi Direct and other specifications like 802.11z, provide the framework for P2P capabilities. These standards ensure compatibility and security, often incorporating encryption methods like WPA2 or WPA3 to protect data integrity and prevent unauthorized access.

With respect to addressing and routing, devices in a P2P group utilize unique identifiers such as MAC addresses to target communications accurately. The use of such identifiers ensures that data packets reach the intended destinations without confusion or misdirection.

Although P2P groups operate independently of an AP device 302 for data transmission, the role of the AP device 302 may still be relevant during initial authentication or resource management. In such cases, the AP device 302 helps to ensure a smooth and secure communication environment even when direct device-to-device communication is the primary mode of data exchange.

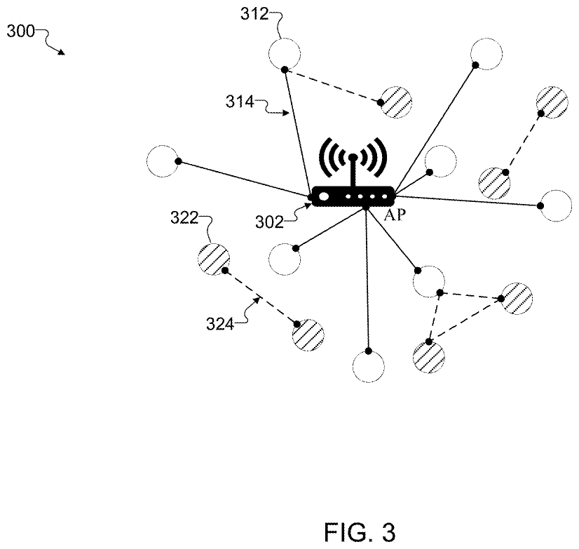

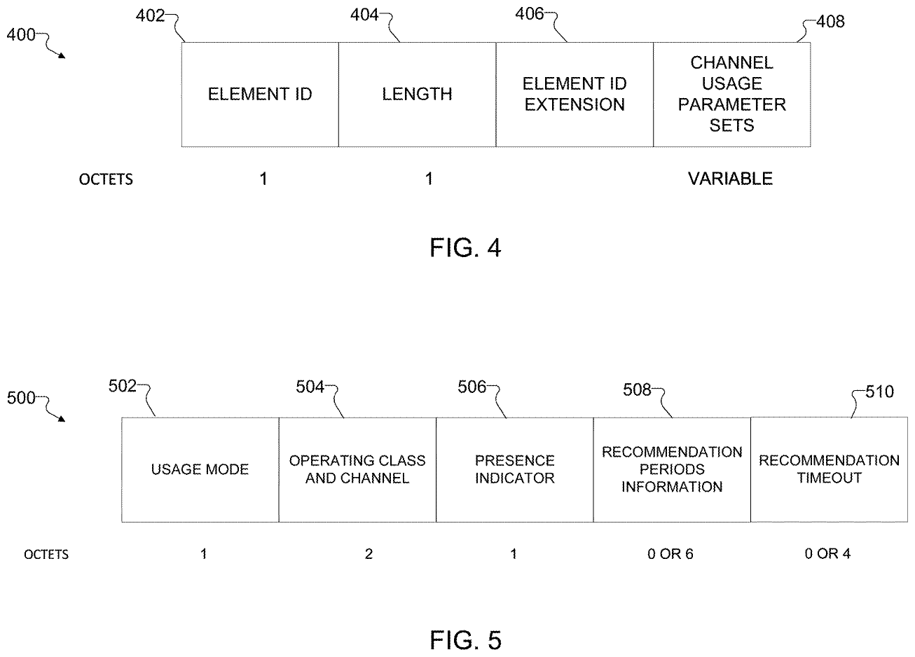

Although FIG. 3 illustrates one example of a P2P communication system 300, various changes may be made to FIG. 3. For example, various components of FIG. 3 could be combined, further subdivided, or omitted and additional components could be added according to particular needs. Additionally, the P2P communication system is configured perform an enhanced channel usage procedure by using an extended channel usage element as shown in FIG. 4.

FIG. 4 illustrates an example extended channel usage element format 400 supporting an enhanced channel usage procedure according to embodiments of the present disclosure. For ease of explanation, the extended channel usage element format 400 will be described as including one or more components of the wireless network 100 of FIG. 1, such as the AP device 102; however, the extended channel usage element format 400 could be implemented using any other suitable device or system. The embodiment of the extended channel usage element format 400 shown in FIG. 4 is for illustration only. Other embodiments of the extended channel usage element format 400 could be used without departing from the scope of this disclosure.

As shown in FIG. 4, the extended channel usage element format 400 includes an element ID field 402, a length field 404, an element ID extension field 406, and a channel usage parameter set field 408.

The element ID 402, length 404, and element ID extension 406 fields are defined in 9.4.2.1 (General) of IEEE 802.11 REVme specification. The extended channel usage element 400 can be used to advertise one or more channel recommendations, such as a first channel recommendation and a second channel recommendation, for P2P communication. The channel usage parameter set field 408 may include one or more channel usage parameter set fields. The channel usage parameter set field 408 is discussed further in FIG. 5.

Although FIG. 4 illustrates one example of an extended channel usage element format 400, various changes may be made to FIG. 4. For example, various components of FIG. 4 could be combined, further subdivided, or omitted and additional components could be added according to particular needs.

FIG. 5 illustrates an example channel usage parameter set field 500 format supporting an enhanced channel usage procedure according to embodiments of the present disclosure. For ease of explanation, the channel usage parameter set field 500 will be described as including one or more components of the wireless network 100 of FIG. 1, such as the AP device 102; however, the channel usage parameter set field 500 could be implemented using any other suitable device or system. The embodiment of the channel usage parameter set field 500 shown in FIG. 5 is for illustration only. Other embodiments of the channel usage parameter set field 500 could be used without departing from the scope of this disclosure.

As shown in FIG. 5, the channel usage parameter set field 500 format includes a usage mode field 502, an operating class and channel field 504, a presence indicator field 506, a recommendation periods information field 508, and a recommendation timeout field 510.

The operating class and channel field 504 is defined in 9.4.1.22 (Operating Class and Channel field) of the IEEE 802.11 REVme specification. The usage mode field is configured to be encoded with a usage mode that includes a channel-usage-aidable basic service set (BSS) that has coordinated with one or more neighboring BSS in providing the channel recommendation identified by an operating class and a channel field of the corresponding channel usage parameter set field. The encoding of the usage mode field 502 is shown in Table 1.

TABLE 1
Usage Mode field encoding

| Value | Usage Mode |
|---|---|
| 0 | Channel-usage-aidable BSS |
| 1 | Off-channel TDLS direct link |
| 2 | Channel-usage-aidable BSS in which none of the channel- |
| | usage-aiding BSSs that belong to the same ESS operate on |
| | the channels identified by the Channel Entry field |
| 3 | Unavailability indication |
| 4 | Channel-usage-aidable BSS channel switch request |
| 5 | Capability notification |
| 6 | Channel-usage-aidable BSS that has coordinated with one |
| | or more neighboring BSS in providing the channel |
| | recommendation identified by the Operating Class and |
| | Channel field of the corresponding Channel Usage |
| | Parameter Set field. |
| 7-254 | Reserved |
| 255 | Unknown request |

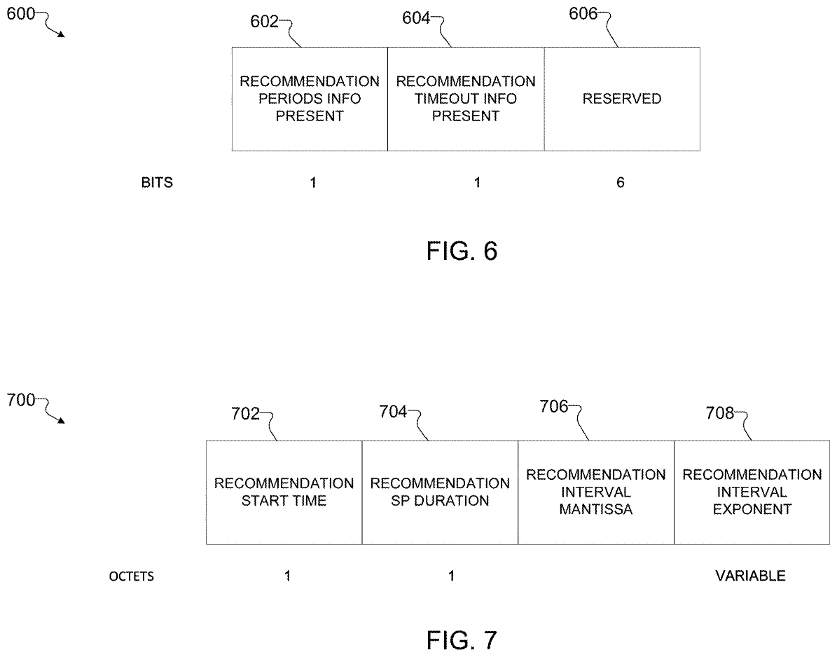

Although FIG. 5 illustrates one example of a channel usage parameter set field 500 format supporting an enhanced channel usage procedure, various changes may be made to FIG. 5. For example, various components of FIG. 5 could be combined, further subdivided, or omitted and additional components could be added according to particular needs. Additionally, the extended channel usage element may include a presence indicator field as shown in FIG. 6.

FIG. 6 illustrates an example presence indicator field 600 supporting an enhanced channel usage procedure according to embodiments of the present disclosure. For ease of explanation, the presence indicator field 600 will be described as including one or more components of the wireless network 100 of FIG. 1, such as the AP device 102; however, the presence indicator field 600 could be implemented using any other suitable device or system. The embodiment of the presence indicator field 600 shown in FIG. 6 is for illustration only. Other embodiments of the presence indicator field 600 could be used without departing from the scope of this disclosure.

As shown in FIG. 6, the presence indicator field 600 includes a recommendation periods info present field 602, a recommendation timeout info present subfield 604, and a reserved field 606.

The recommendation periods info present subfield 602 in the channel usage parameter set 500 indicates whether or not the recommendation periods information field 508 is present in the corresponding channel usage parameter set 500. If the subfield is set to 1, then the recommendation periods information field 508 is present in the channel usage parameter set 500; otherwise, it is not present. The recommendation timeout info present subfield 604 indicates whether or not the recommendation timeout field 510 is present in the channel usage parameter set 500. If the subfield is set to 1, then the recommendation timeout field 510 is present in the channel usage parameter set 500; otherwise, it is not present. The recommendation periods information field 508 describes a series of time windows during which the channel recommendation identified by this parameter set applies.

Although FIG. 6 illustrates one example of a presence indicator field 600, various changes may be made to FIG. 6. For example, various components of FIG. 6 could be combined, further subdivided, or omitted and additional components could be added according to particular needs. Additionally, the extended channel usage element may include a recommendation periods information field as shown in FIG. 7.

FIG. 7 illustrates an example recommendation periods information field format 700 supporting an enhanced channel usage procedure according to embodiments of the present disclosure. For ease of explanation, the recommendation periods information field format 700 will be described as including one or more components of the wireless network 100 of FIG. 1, such as the AP device 102; however, the recommendation periods information field format 700 could be implemented using any other suitable device or system. The embodiment of the recommendation periods information field format 700 shown in FIG. 7 is for illustration only. Other embodiments of the recommendation periods information field format 700 could be used without departing from the scope of this disclosure.

As shown in FIG. 7, the recommendation periods information field format 700 includes a recommendation start time field 702, a recommendation SP duration field 704, a recommendation interval mantissa subfield 706, and a recommendation interval exponent subfield 708.

The recommendation start time field 702 contains a positive unsigned integer corresponding to the time synchronization function (TSF) value of the AP device 302 advertising this element indicating the start time of the first service period (SP) in the series of SPs described by this extended channel usage element. The lowest bit of the recommendation start time field 702 is set to bit 10 of the corresponding TSF value of the advertising AP device 302.

The recommendation SP duration field 704 indicates the duration of time, in units of time, such as in time units (TUs), during which the channel recommendation advertised by this channel usage parameter set applies. The recommendation interval mantissa subfield 706 is set to the value of the mantissa of the recommendation SP interval value in units of time, such as in microseconds, to the base 2. The recommendation interval exponent subfield 708 is set to the value of the exponent of the recommendation SP interval value in units of time, such as in microseconds, to the base 2. The recommendation Timeout field in the Channel Usage Parameter Set field contains an unsigned 32-bit integer, indicating the lifetime of the channel recommendation, in units of time, such as in TUs.

Although FIG. 7 illustrates one example of a recommendation periods information field format 700 supporting an enhanced channel usage procedure, various changes may be made to FIG. 7. For example, various components of FIG. 7 could be combined, further subdivided, or omitted and additional components could be added according to particular needs.

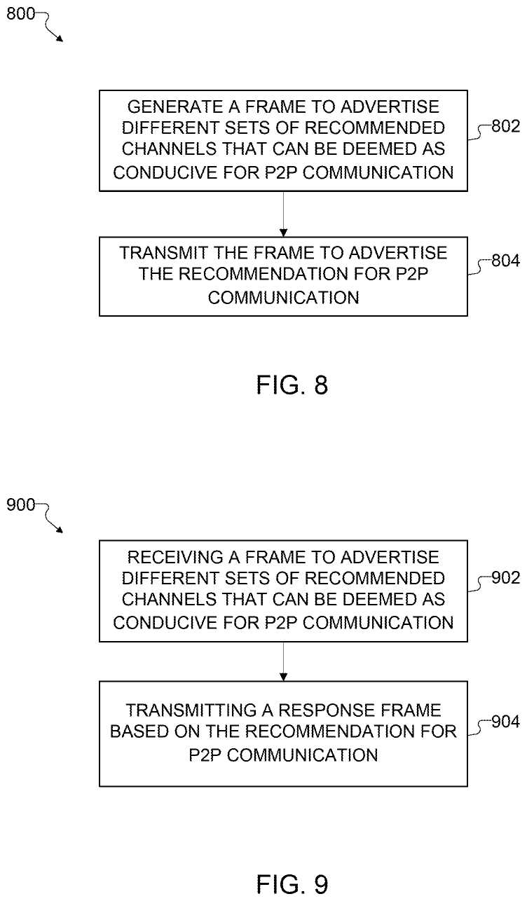

FIG. 8 illustrates an example flow chart of a method 800 for an extended channel usage procedure according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments of the extended channel usage procedure could be used without departing from the scope of this disclosure.

As shown in FIG. 8, a frame is generated to advertise different sets of recommended channels that can be deemed as conducive for P2P communication at step 802. For example, the AP device 302 may generate a frame, such as a beacon, a probe response, a (Re) association response frame, a (Protected) management frame, a (Protected) public action frame, or a combination thereof, to recommended channels for P2P communication. The recommended channels may be advertised in a frame that includes an extended channel usage element having the extended channel usage element format 400. Each recommended channel information can be included in a channel usage parameter set field 408 of the extended channel usage element 400. In the corresponding channel usage parameter set field 408, the AP device 302 can also include a recommendation periods information field 508 indicating a series of time windows during which the channel recommendation identified by this channel usage parameter set is applicable. In the corresponding channel usage parameter set field 408, the AP device 302 may also contain a recommendation timeout field 510 indicating the time when the channel recommendation identified by this parameter set field expires. If the recommendation periods information field 508 is not present in the channel usage parameter set, then it means that the channel recommendation identified by this parameter set is applicable at all time (until the recommendation is ended). If the recommendation timeout field 510 is not present in the channel usage parameter set, then it means that the channel recommendation identified by the parameter set is valid until the recommendation is ended (such as, until the time when that channel usage parameter set fields 408 are no longer carried in the extended channel usage element).

The frame is transmitted to advertise the recommendation for P2P communication at step 804. For example, the AP device 302 may transmit the frame to advertise channel recommendations for P2P communication.

Although FIG. 8 illustrates one example method for an extended channel usage procedure, various changes may be made to FIG. 8. For example, while shown as a series of steps, various steps in FIG. 8 could overlap, occur in parallel, occur in a different order, or occur any number of times.

FIG. 9 illustrates an example method 900 for an extended channel usage procedure according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments of the extended channel usage procedure could be used without departing from the scope of this disclosure.

As shown in FIG. 9, receiving a frame to advertise different sets of recommended channels that can be deemed as conducive for P2P communication at step 902. For example, the associated STA 312 (or the unassociated STA 322), may receive a frame advertised by the AP device 302 that includes channel recommendations for P2P communication. The recommended channels may be advertised in a frame that includes an extended channel usage element having the extended channel usage element format 400.

A response frame may be transmitted based on the recommendation for P2P communication at step 904. For example, the associated STA 312 (or the unassociated STA 322) may transmit a response frame accepting the channel recommendations in the frame to initiate P2P communication with others of the associated STA 312 or the unassociated STA 322.

Although FIG. 9 illustrates one example method for an extended channel usage procedure, various changes may be made to FIG. 9. For example, while shown as a series of steps, various steps in FIG. 9 could overlap, occur in parallel, occur in a different order, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by an access point (AP) device, the method comprising:
generating a frame to advertise different sets of recommended channels that can be deemed as conducive for peer-to-peer (P2P) communication, the frame including an extended channel usage element that includes:
a channel usage parameter set field including one or more channel recommendations; and
for a first of the one or more channel recommendations:
a recommendation periods information field in the channel usage parameter set field, the recommendation periods information field indicating a series of time windows during which the first channel recommendation identified by the channel usage parameter set field is applicable; and
a recommendation timeout information field in the channel usage parameter set field, the recommendation timeout information field indicating a time when the first channel recommendation identified by the channel usage parameter set field expires; and
transmitting the frame to advertise the recommendation for P2P communication.

2. The method of claim 1, wherein, for a second of the one or more channel recommendations identified by the channel usage parameter set field:
a recommendation periods information field is not present in the channel usage parameter set field, which indicates that the second channel recommendation identified by the channel usage parameter set field is applicable at all time; and
a recommendation timeout information field is not present in the channel usage parameter set field, which indicates that the second channel recommendation identified by the channel usage parameter set field is valid until the second channel recommendation is ended.

3. The method of claim 1, wherein the frame comprises at least one of a beacon, a probe response, a (Re) association response frame, a (Protected) management frame, or a (Protected) public action frame.

4. The method of claim 1, wherein the extended channel usage element further includes a usage mode field configured to be encoded with a usage mode that includes a channel-usage-aidable basic service set (BSS) that has coordinated with one or more neighboring BSS in providing the one or more channel recommendations identified by an operating class and a channel field of the corresponding channel usage parameter set field.

5. The method of claim 1, wherein the channel usage parameter set field includes one or more channel usage parameter set fields.

6. The method of claim 1, wherein the recommendation periods information field includes a recommendation start time field, a recommendation service period (SP) duration field, a recommendation interval mantissa subfield, and a recommendation interval exponent subfield.

7. The method of claim 6, wherein:
the recommendation start time field contains a positive unsigned integer corresponding to a time synchronization function (TSF) value of the AP device advertising this element indicating the start time of a first SP in the series of SPs described by this extended channel usage element, wherein the lowest bit of the recommendation start time field is set to bit 10 of the corresponding TSF value of the AP device;
the recommendation SP duration field indicates the duration of time during which the channel recommendation advertised by this channel usage parameter set applies;
the recommendation interval mantissa subfield is set to the value of the mantissa of a recommendation SP interval value;
the recommendation interval exponent subfield is set to the value of the exponent of the recommendation SP interval value; and
the recommendation timeout field in the channel usage parameter set field contains an unsigned 32-bit integer, indicating a lifetime of the channel recommendation.

8. A method performed by a non-access point (AP) station (STA), the method comprising:
receiving a frame to advertise different sets of recommended channels that can be deemed as conducive for peer-to-peer (P2P) communication, the frame including an extended channel usage element that includes:
a channel usage parameter set field including one or more channel recommendations; and
for a first of the one or more channel recommendations:
a recommendation periods information field in the channel usage parameter set field, the recommendation periods information field indicating a series of time windows during which the first channel recommendation identified by the channel usage parameter set field is applicable; and
a recommendation timeout information field in the channel usage parameter set field, the recommendation timeout information field indicating a time when the first channel recommendation identified by the channel usage parameter set field expires; and
transmitting a response frame based on the recommendation for P2P communication.

9. The method of claim 8, wherein, for a second of the one or more channel recommendations identified by the channel usage parameter set field:
a recommendation periods information field is not present in the channel usage parameter set field, which indicates that the second channel recommendation identified by the channel usage parameter set field is applicable at all time; and
a recommendation timeout information field is not present in the channel usage parameter set field, which indicates that the second channel recommendation identified by the channel usage parameter set field is valid until the second channel recommendation is ended.

10. The method of claim 8, wherein the frame comprises at least one of a beacon, a probe response, or a (Re) association response frame, or a (Protected) management frame, or a (Protected) Public Action field/frame.

11. The method of claim 8, wherein the extended channel usage element further includes a usage mode field configured to be encoded with a usage mode that includes a channel-usage-aidable basic service set (BSS) that has coordinated with one or more neighboring BSS in providing the one or more channel recommendations identified by an operating class and a channel field of the corresponding channel usage parameter set field.

12. The method of claim 8, wherein the channel usage parameter set field includes one or more channel usage parameter set fields.

13. The method of claim 8, wherein the recommendation periods information field includes a recommendation start time field, a recommendation service period (SP) duration field, a recommendation interval mantissa field, and a recommendation interval exponent subfield.

14. The method of claim 13, wherein:
the recommendation start time field contains a positive unsigned integer corresponding to a time synchronization function (TSF) value of an AP device advertising this element indicating the start time of a first SP in the series of SPs described by this extended channel usage element, wherein the lowest bit of the recommendation start time field is set to bit 10 of the corresponding TSF value of the AP device;
the recommendation SP duration field indicates the duration of time during which a channel recommendation advertised by this channel usage parameter set applies;
the recommendation interval mantissa field is set to the value of the mantissa of a recommendation SP interval value;
the recommendation interval exponent subfield is set to the value of the exponent of the recommendation SP interval value; and
the recommendation timeout field in the channel usage parameter set field contains an unsigned 32-bit integer, indicating a lifetime of the channel recommendation.

15. An electronic device, comprising:
a transceiver; and
a processor operably coupled to the transceiver, configured to cause the electronic device to:
generate a frame to advertise different sets of recommended channels that can be deemed as conducive for peer-to-peer (P2P) communication, the frame including an extended channel usage element that includes:
a channel usage parameter set field including one or more channel recommendations; and
for a first of the one or more channel recommendations:
a recommendation periods information field in the channel usage parameter set field, the recommendation periods information field indicating a series of time windows during which the first channel recommendation identified by the channel usage parameter set field is applicable; and
a recommendation timeout information field in the channel usage parameter set field, the recommendation timeout information field indicating a time when the first channel recommendation identified by the channel usage parameter set field expires; and
transmit the frame to advertise the recommendation for P2P communication.

16. The electronic device of claim 15, wherein the processor is further configured to cause the electronic device to, for a second of the one or more channel recommendations identified by the channel usage parameter set field:
a recommendation periods information field is not present in the channel usage parameter set field, which indicates that the second channel recommendation identified by the channel usage parameter set field is applicable at all time; and
a recommendation timeout information field is not present in the channel usage parameter set field, which indicates that the second channel recommendation identified by the channel usage parameter set field is valid until the second channel recommendation is ended.

17. The electronic device of claim 15, wherein the frame comprises at least one of a beacon, a probe response, or a (Re) association response frame, or a (Protected) management frame, or a (Protected) Public Action field/frame.

18. The electronic device of claim 15, wherein the extended channel usage element further includes a usage mode field configured to be encoded with a usage mode that includes a channel-usage-aidable basic service set (BSS) that has coordinated with one or more neighboring BSS in providing the one or more channel recommendations identified by an operating class and a channel field of the corresponding channel usage parameter set field.

19. The electronic device of claim 15, wherein the channel usage parameter set field includes one or more channel usage parameter set fields.

20. The electronic device of claim 15, wherein the recommendation periods information field includes a recommendation start time field, a recommendation service period (SP) duration field, a recommendation interval mantissa field, and a recommendation interval exponent subfield, wherein:
the recommendation start time field contains a positive unsigned integer corresponding to a time synchronization function (TSF) value of an AP device advertising this element indicating the start time of a first SP in the series of SPs described by this extended channel usage element, wherein the lowest bit of the recommendation start time field is set to bit 10 of the corresponding TSF value of the AP device;
the recommendation SP duration field indicates the duration of time during which a channel recommendation advertised by this channel usage parameter set applies;
the recommendation interval mantissa field is set to the value of the mantissa of a recommendation SP interval value;
the recommendation interval exponent subfield is set to the value of the exponent of the recommendation SP interval value; and
the recommendation timeout field in the channel usage parameter set field contains an unsigned 32-bit integer, indicating a lifetime of the channel recommendation.
